(19) United States
(12) Patent Application Publication
(10) Pub. No.: US 2014/0074968 A1
(43) Pub. Date: Mar. 13, 2014

(54) MANAGING A SERVER NODE INFRASTRUCTURE

(71) Applicants: ULF FILDEBRANDT, Oftersheim (DE); FRANK OLIVER HOFFMANN, Wieslock (DE); ANDRE HILDEBRANDT, Heidelberg (DE); OLIVER KIESELBACH, Bielefeld (DE)

(72) Inventors: ULF FILDEBRANDT, Oftersheim (DE); FRANK OLIVER HOFFMANN, Wieslock (DE); ANDRE HILDEBRANDT, Heidelberg (DE); OLIVER KIESELBACH, Bielefeld (DE)

(73) Assignee: SAP AG, Walldorf (DE)

(21) Appl. No.: 13/611,391

(22) Filed: Sep. 12, 2012

(51) Int. Cl. G06F 15/16

(52) U.S. Cl. 709/217

(57) ABSTRACT

Techniques for managing nodes include receiving a message from a particular tenant of a plurality of tenants; identifying a particular node of a plurality of nodes that is based on the message and that is mapped to the particular tenant, each node providing one or more functionalities and each tenant mapped to one or more nodes; identifying a particular version, of one or more versions, of the particular node that is based on the message, the particular tenant mapped to each version of the particular node; and providing the message to the particular version of the particular node.

### TECHNICAL BACKGROUND

This disclosure relates to managing server-nodes, and more specifically, managing virtual machines represented as nodes.

### BACKGROUND

Computer applications frequently process data provided by systems from different domains, with the different systems providing data in different formats or protocols. In some instances, the complexity of the data exchanged between different systems, the large amounts of data, incompatibilities among different formats, and other factors may result in inefficiencies when applications receive, process, and transmit data to and from different sources across a network. Some solutions, including a variety of programming paradigms such as Service-Oriented Architecture (SOA) systems, are designed for handling large amounts of data shared among multiple systems. Even in SOA systems, the data may be copied from one system to another system by passing the data as messages. Systems that share or exchange data, including systems that provide or receive on-demand services through a cloud network, may require efficient solutions for providing large amounts of data to different applications.

### SUMMARY

The present disclosure relates to computer-implemented methods, software, and systems for managing nodes. In some embodiments, a message is received from a particular tenant of multiple tenants. In some examples, the tenants are associated with one or more users that access a server cluster hosting the nodes. A particular node of the multiple nodes is identified that is based on the received message and that is mapped to the particular tenant. Each of the nodes of the multiple nodes provides one or more functionalities and each tenant is mapped to one or more nodes. In some examples, the nodes are virtual machines. In some examples, the nodes are heterogeneous nodes such that each node (e.g., each virtual machine) provides ones or more differing functionalities. In some examples, each node is mapped to only one tenant. A particular version of the particular node is identified that is based on the message. In some examples, the particular node can include one or more versions. The particular tenant is mapped to each version of the particular node. The message is provided to the particular version of the particular node. In some examples, the nodes associated with each tenant are isolated from the nodes associated with each remaining tenant.

A general embodiment of the subject described in this disclosure can be implemented in methods that include receiving a message from a particular tenant of multiple tenants; identifying a particular node of multiple nodes that is based on the message and that is mapped to the particular tenant, each node providing one or more functionalities and each tenant mapped to one or more nodes; identifying a particular version, of one or more versions, of the particular node that is based on the message, the particular tenant mapped to each version of the particular node; and providing the message to the particular version of the particular node.

Other general embodiments include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

A first aspect combinable with any of the general embodiments includes isolating the nodes associated with each tenant from the nodes associated with each remaining tenant.

A second aspect combinable with any of the previous aspects further includes substantially preventing access of resources associated with each node by the remaining nodes.

A third aspect combinable with any of the previous aspects further includes each node being mapped to only one tenant, each tenant including a set of users accessing one or more physical entities providing the nodes.

A fourth aspect combinable with any of the previous aspects includes each node being a virtual machine.

A fifth aspect combinable with any of the previous aspects further includes the multiple nodes including multiple heterogeneous nodes such that each node of the multiple heterogeneous nodes provides differing functionalities.

A sixth aspect combinable with any of the previous aspects further includes the multiple nodes including multiple heterogeneous nodes such that one or more nodes of the multiple heterogeneous nodes includes two or more differing versions.

Various embodiments of a computing system according to the present disclosure may have one or more of the following features. For example, the system facilitates improved scaling of functionality (of the virtual machines represented as nodes); reduced footprint of the nodes and of the cluster supporting the nodes; improved version handling of the nodes; improved upgrade mechanisms; improved solution for multi-tenancy; and improved fault tolerance.

The details of one or more embodiments of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for managing nodes;

FIG. 2 illustrates an example environment of a distributed computing system operable to manage nodes;

FIG. 3 illustrates a graphical depiction of the categorization of the nodes; and

FIG. 4 is a flow chart illustrating an example method for managing nodes in a distributed computing system.

### DETAILED DESCRIPTION

This disclosure generally describes computer-implemented methods, software, and systems for managing nodes. In some embodiments, a message is received from a particular tenant of multiple tenants. In some examples, the tenants are associated with one or more users that access a server cluster hosting the nodes. A particular node of the multiple nodes is identified that is based on the received message and that is mapped to the particular tenant. Each of the nodes of the multiple nodes provides one or more functionalities and each tenant is mapped to one or more nodes. In some examples, the nodes are virtual machines. In some examples, the nodes are heterogeneous nodes such that each node (e.g., each virtual machine) provides ones or more differing functionalities. In some examples, each node is mapped to only one tenant. A particular version of the particular node is identified that is based on the message. In some examples, the particular node can include one or more versions. The particular tenant is mapped to each version of the particular node. The message is provided to the particular version of the particular node. In some examples, the nodes associated with each tenant are isolated from the nodes associated with each remaining tenant.

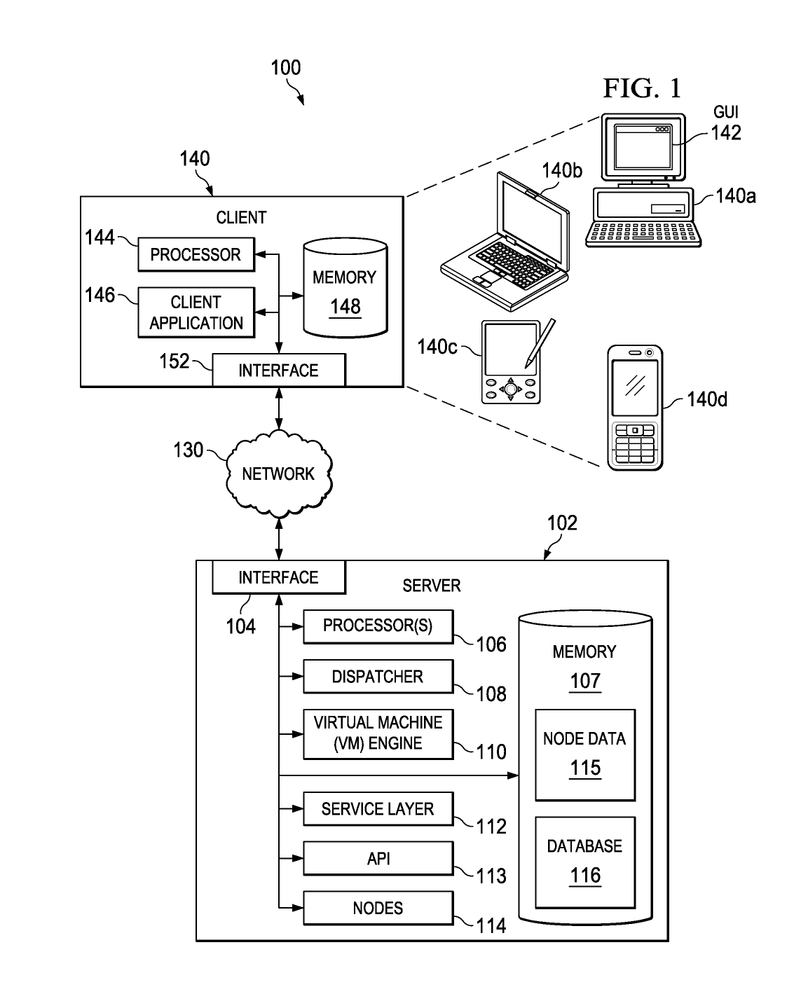

FIG. 1 illustrates an example distributed computing system 100 for managing nodes. At a high-level, the illustrated example distributed computing system 100 includes or is communicably coupled with a server 102 (e.g., a distributed server/cluster) and clients 140a-140c (collectively client 140) that communicate across a network 130. The server 102 comprises a computer operable to receive, transmit, process, store, or manage data and information associated with the example distributed computing system 100. In general, the server 102 is a server that stores a dispatcher 108, a virtual machine (VM) engine 110, a service layer 112, an application programming interface (API) 113, and nodes 114 where at least a portion of the dispatcher 108, the VM engine 110, the service layer 112, the API 113, and the nodes 114 is executed using requests and responses sent to a client 140 within and communicably coupled to the illustrated example distributed computing system 100 across the network 130.

The server 102 is responsible for receiving application requests (e.g., messages), from one or more client applications associated with the client 140 of the example distributed computing system 100 and responding to the received requests by processing said requests in the dispatcher 108 and/or the VM engine 110, and sending an appropriate response from the dispatcher 108 and/or VM engine 110 back to the requesting client application. In addition to requests from the client 140, requests associated with the dispatcher 108 and/or the VM engine 110 may also be sent from internal users, external or third-party customers, other automated applications, as well as any other appropriate entities, individuals, systems, or computers. According to some implementations, server 102 may also include or be communicably coupled with an e-mail server, a web server, a caching server, a streaming data server, and/or other appropriate server. In some implementations, the server 102 and related functionality may be provided in a cloud-computing environment.

The dispatcher 108 manages the nodes 114 (e.g., virtual machines). The dispatcher 108 receives a message, for example, from a particular client 140. The dispatcher 108 identifies a particular node 114 that is (i) based on the message and that is (ii) mapped to the particular client 140. The dispatcher 108 then identifies a particular version of the identified particular node 114 that is also based on the received message. The dispatcher 108 provides the message to the particular version of the particular node 114. The VM engine 110 facilitates or otherwise provides execution of the nodes 114 (e.g., the virtual machines), and in particular, the particular version of the particular node 114. Additionally, the VM engine 100 facilitates or otherwise provides isolation of requests from the clients 140.

The server 102 includes an interface 104. Although illustrated as a single interface 104 in FIG. 1, two or more interfaces 104 may be used according to particular needs, desires, or particular implementations of the example distributed computing system 100. The interface 104 is used by the server 102 for communicating with other systems in a distributed environment—including within the example distributed computing system 100—connected to the network 130; for example, the client 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The server 102 includes a processor 106. Although illustrated as a single processor 106 in FIG. 1, two or more processors may be used according to particular needs, desires, or particular implementations of the example distributed computing system 100. Generally, the processor 106 executes instructions and manipulates data to perform the operations of the server 102. Specifically, the processor 106 executes the functionality required to receive and respond to requests from the client 140.

The server 102 also includes a memory 107 that holds data for the server 102. Although illustrated as a single memory 107 in FIG. 1, two or more memories may be used according to particular needs, desires, or particular implementations of the example distributed computing system 100. While memory 107 is illustrated as an integral component of the server 102, in some implementations, the memory 107 can be external to the server 102 and/or the example distributed computing system 100. In some implementations, the memory 107 includes a database 116 and node data 115.

In some implementations, the nodes 114 are virtual machines such that the nodes 114 can appropriately process an incoming message, such as from one of the clients 140. In some examples, the nodes 114 can include, or have appropriate access to, software, including an operating system containing runtime packages necessarily for any runtime components, the application server runtimes and frameworks. In some examples, the nodes 114 are executed, stored, or otherwise appropriately processed, by the server 102 and/or the VM engine 110. In some examples, the server 102 can include one or more server computing devices (e.g., a server farm or server cluster), with each server computing device including one or more processing units (e.g., “multi-core”). The nodes 114 can be associated (e.g., executed by) differing numbers of cores (e.g., 2-core, 3-core, 4-core, etc.) based on parameters such as memory (RAM) consumption, data I/O parameters network traffic, calculations necessary, and other appropriate parameters.

The nodes 114 can be characterized by, at least, three differing categories (e.g., “dimensions”): function, version, and tenant. With respect to the function category (e.g., function “dimension”), each of the nodes 114 provides (e.g., performs or executes) one or more functionalities. For example, the functionalities of the nodes 114 can include execution (e.g., running of data services) of message communication, running process instances, and monitoring the system (e.g., the distributed computing system 100 or the server 102). In some examples, the nodes 114 are heterogeneous nodes. In other words, each of the nodes 114 provides differing functionalities. To coordinate work (e.g., processing) between the nodes 114 (as each node 114 provides or performs a differing function), the nodes 114 can communicate with each other node 114 (or a subset of each other node 114). In some examples, the communication between the nodes 114 is done via transmission control protocol/internet protocol (TCP/IP) multicast and hypertext transfer protocol secure (HTTPS).

Additionally, with respect to the version category (e.g., version “dimension”), the nodes 114 can include different versions. Specifically, a particular node 114 can include a first version and a second version of the particular node 114. The first version of the particular node 114 can be an older version of the particular node 114, while the second version of the particular node 114 can be a newer (e.g. updated) version of the particular node 114. In some examples, each of the versions of a particular node 114 can be available or supported simultaneously.

Furthermore, with respect to the tenant category (e.g., tenant “dimension”), in some examples, each node 114 is mapped to (associated with) a single tenant. In some examples, a tenant can be associated with a group of users (such as clients 140) assigned to or that access the node 114. In some examples, the tenant can be associated with only one client 140, or can include two or more clients 140. In some examples, the tenant can be associated with a person, a group of people (such as a project team), or an organization of people (such as a company). In some examples, each tenant is mapped to (e.g., associated with) to one or more of the nodes 114. In some examples, each node 114 is mapped to (e.g., associated with) only one tenant while each tenant can be mapped to (e.g., associated with) one or more nodes 114. Moreover, for each version of a particular node 114, a tenant that is associated with (or mapped to) a particular node 114 is also mapped to (or associated with) each version of the particular node 114.

In some embodiments, the server 102 further includes a mappings database (not shown) that stores the mappings (associations) between the nodes 114 and the tenants.

The database 116 and/or the node data 115 stores information associated with storage operations, for example, logs, traces, monitoring information, technical states of processes, and messages. In some examples, the database 116 can be a structured query language (SQL) database. In general, the database 116 supports isolation of resources associated with each of the nodes 114 (and/or tenants), isolation of the nodes 114, and/or versioning of the nodes 114, described further below. In some examples, the database 116 can represent one or more databases.

The server 102 further includes a service layer 112. The service layer 112 provides software services to the example distributed computing system 100. The functionality of the server 102 may be accessible for all service consumers using this service layer. For example, in one implementation, the client 140 can utilize service layer 112 to communicate with the dispatcher 108 or the VM engine 110. Software services provide reusable, defined business functionalities through a defined interface. While illustrated as an integrated component of the server 102 in the example distributed computing system 100, alternative implementations may illustrate the service layer 112 as a stand-alone component in relation to other components of the example distributed computing system 100. Moreover, any or all parts of the service layer 112 may be implemented as child or sub-modules of another software module, enterprise application, or hardware module without departing from the scope of this disclosure.

The server 102 further includes an application programming interface (API) 113. In some implementations, the API 113 can be used to interface between the dispatcher 108, the VM engine 110, and/or one or more components of the server 102 or other components of the example distributed computing system 100, both hardware and software. For example, in one implementation, the dispatcher 108 can utilize API 113 to communicate with the VM engine 110, and/or the client 140. The API 113 may include specifications for routines, data structures, and object classes. The API 113 may be either computer language independent or dependent and refer to a complete interface, a single function, or even a set of APIs. While illustrated as an integrated component of the server 102 in the example distributed computing system 100, alternative implementations may illustrate the API 113 as a stand-alone component in relation to other components of the example distributed computing system 100. Moreover, any or all parts of the API 113 may be implemented as child or sub-modules of another software module, enterprise application, or hardware module without departing from the scope of this disclosure.

The client 140 may be any computing device operable to connect to or communicate with at least the server 102 using the network 130. In general, the client 140 comprises a computer operable to receive, transmit, process, and store any appropriate data associated with the example distributed computing system 100. The illustrated client 140 further includes a client application 146. The client application 146 is any type of application that allows the client 140 to request and view content on the client 140. In some implementations, the client application 146 can be and/or include a web browser. In some implementations, the client-application 146 can use parameters, metadata, and other information received at launch to access a particular set of data from the server 102. Once a particular client application 146 is launched, a user may interactively process a task, event, or other information associated with the server 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the example distributed computing system 100—connected to the network 130; for example, the server 102 as well as other systems communicably coupled to the network 130 (not illustrated). The interface 152 may also be consistent with the above-described interface 104 of the server 102 or other interfaces within the example distributed computing system 100. The processor 144 may be consistent with the above-described processor 106 of the server 102 or other processors within the example distributed computing system 100. Specifically, the processor 144 executes instructions and manipulates data to perform the operations of the client 140, including the functionality required to send requests to the server 102 and to receive and process responses from the server 102. The memory 148 may be consistent with the above-described memory 107 of the server 102 or other memories within the example distributed computing system 100 but storing objects and/or data associated with the purposes of the client 140.

Further, the illustrated client 140 includes a GUI 142. The GUI 142 interfaces with at least a portion of the example distributed computing system 100 for any suitable purpose, including generating a visual representation of a web browser. In particular, the GUI 142 may be used to view and navigate various web pages located both internally and externally to the server 102. Generally, through the GUI 142, a server 102 user is provided with an efficient and user-friendly presentation of data provided by or communicated within the example distributed computing system 100.

There may be any number of clients 140 associated with, or external to, the example distributed computing system 100. For example, while the illustrated example distributed computing system 100 includes one client 140 communicably coupled to the server 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual information, or a GUI 142, as shown with respect to the client 140. In some implementations, the client 140 includes an application server or an enterprise server.

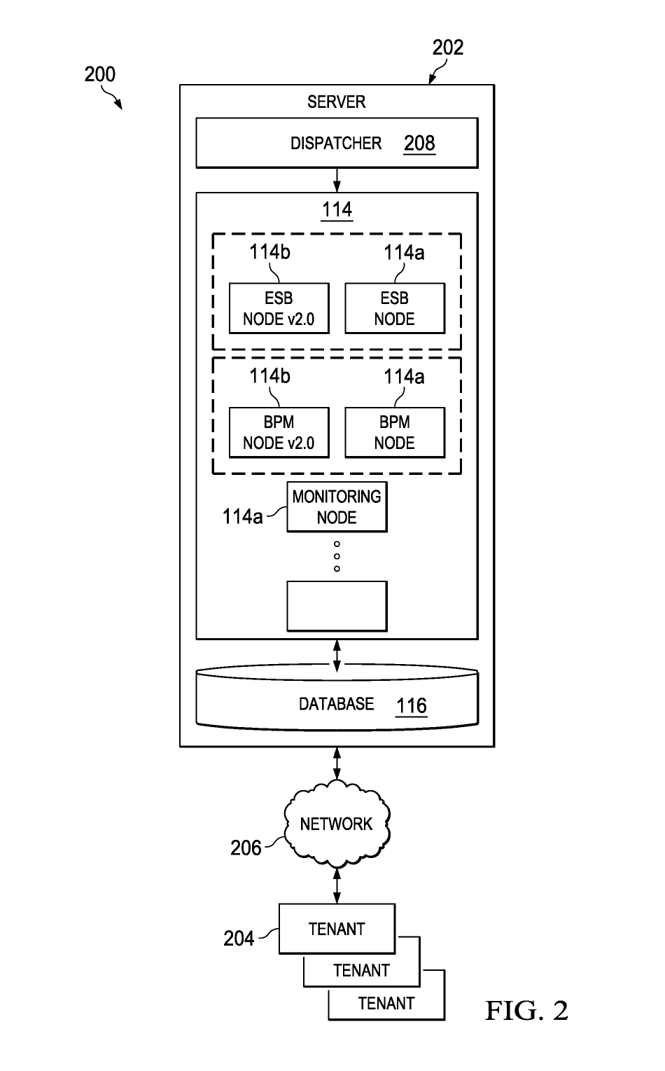

FIG. 2 illustrates an example environment 200 of a distributed computing system operable to manage nodes. The environment 200 includes a server 202 (analogously to the server 102 of FIG. 1) and a tenant 204 that communicate across a network 206 (analogous to the network 142 of FIG. 1). The tenant 204 includes the appropriate computing modules/components needed for operation and execution of processes by the tenant, similar to that mentioned above with respect to the client 140.

The server 202 includes a dispatcher 208 (analogous to the dispatcher 108), nodes 114 (mentioned above with respect to FIG. 1), and a database 116 (mentioned above with respect to FIG. 1). The server 102 receives a message from the tenant 204 via the network 206. The message can include any representation of data, such as text, XML, or binary. In some examples, the message is received by, or provided to, the dispatcher 208. The dispatcher 208 provides the message to the appropriate node 114, as determined by the contents of the message and the tenant 204 providing the message, described further below. The nodes 114 access the database 116 in support of the received messages such that the nodes 114 can process or otherwise appropriately handle the received message.

In the depicted example, the nodes 114 include an enterprise service bus (ESB) node 114, a business process management (BPM) node 114, and a monitoring node 114. Additionally, the ESB node 114 includes a first version (shown as ESB node 114a) and a second version (shown as ESB node 114b); and the BPM node 114 includes a first version (shown as BPM node 114a) and a second version (shown as BPM node 114b). As shown, the server 202 includes three nodes 114, with the ESB node 114 and the BPM node 114 including two versions. However, the server 202 can include any number of nodes 114, and any number of versions of any number of the nodes 114.

To that end, in some examples, the nodes 114 are managed. Specifically, in some embodiments, a message is received from a particular tenant 204 of the multiple tenants 204. In some examples, the tenants 204 are associated with one or more users that access a server (such as the server 202) or a server cluster hosting or otherwise providing the nodes 114. A particular node 114 of the multiple nodes 114 is identified that is based on (i) the received message and (ii) that is mapped to the particular tenant 204. Each of the nodes 114 of the multiple nodes 114 provides one or more functionalities and each tenant 204 is mapped to one or more nodes 114. In some examples, the nodes 114 are virtual machines. In some examples, the nodes 114 are heterogeneous nodes 114 such that each node 114 (e.g., each virtual machine) provides ones or more differing functionalities. In some examples, each node 114 is mapped to only one tenant 204. A particular version of the particular node 114 is identified that is based on the message. The particular node 114 can include one or more versions. The particular tenant 204 is mapped to each version of the particular node 114. The message is provided to the particular version of the particular node 114. In some examples, the nodes 114 associated with each tenant 204 are isolated from the nodes 114 associated with each remaining tenant 204.

Specifically, in some embodiments, a message is received from a particular tenant 204 of the multiple tenants 204. The message can include any representation of data, such as text, XML or binary. In some examples, the message can be associated with the particular tenant 204. For example, the message can be “tagged” with an association with the particular tenant 204. In some examples, the metadata of the message can include the association with the particular tenant 204. In some embodiments, the server 202 and/or the dispatcher 208 receives the message.

A particular node 114 is identified of the multiple nodes 114 that is (i) based on the message and that is (ii) mapped to the particular tenant 204 (i.e., the node 114 that provides the message). Each of the multiple nodes 114 provides one or more functionalities. As a criterion, a particular node 114 is identified that provides the functionality that the message is associated with. In other words, the particular node 114 that provides a functionality to appropriately process the message (i.e., perform a desired function associated with the message) is identified. Additionally, as a criterion, the particular node 114 is identified that is mapped to the particular tenant 204. In some examples, each node 114 is mapped to only one tenant 204. Thus, while multiple nodes 114 may provide the same functionality, the node 114 that offers the identified functionality and that is associated with the particular tenant 204 is identified. In some examples, the message is associated with the ESB node 114 (or the BPM node 114). In some embodiments, the dispatcher 208 identifies the particular node 114.

In some examples, each tenant 204 is mapped to one or more nodes 114. Specifically, each tenant 204 may need to access or utilize nodes 114 having differing functionalities (depending on the message). Thus, each tenant 204 can be mapped to one or more nodes 114 to access or utilize the differing functionalities provided by the nodes 114. In some examples, the nodes 114 are virtual machines.

In some embodiments, each node 114 is mapped to only one tenant 204. Specifically, each node 114 is associated with (or mapped) to only one tenant 204 to minimize, if not prevent, access to a particular node 114 from a tenant 204 that is not authorized to access the particular node 114, and the resources associated with the particular node 114, described further below. In some examples, each tenant 204 includes a set of users (e.g., a corporation) accessing one or more physical entities (e.g., the server 202) that provide the multiple nodes 114.

In some embodiments, the nodes 114 associated with each tenant 204 are isolated from the nodes 114 associated with each remaining tenant 204. Specifically, by identifying the particular node 104 based on the particular tenant 204, the nodes 114 are isolated from each other. In some examples, by isolating the nodes 114 from each other, the respective tenants 204 are also isolated from each other. Specifically, multiple tenants 204 may share (e.g., access) a single physical server (e.g., server 202) and a single database (e.g., database 116). To ensure that messages sent via the network 206 are secure and are properly forwarded to the appropriate node 114 (e.g., to prevent unauthorized access to the message and/or data associated with the message), the tenants 204, the nodes 114, and/or the resources associated with the nodes 114 (e.g., the data stored by the database 116) are isolated from one another. For example, one of the tenants 204 can include a banking corporation, and such, messages provided by a banking corporation tenant 204 are to be secure and follow certain transfer protocols/standards (e.g., Secure Sockets Layer (SSL) for HTTPS, Secure Shell (SSH) for Secret File Transfer Protocol (SFTP), Public-Key Cryptography Standards (PKCS), Pretty Good Privacy (PGP), and Extensible Markup Language (XML) digital signature).

In some embodiments, access is substantially prevented of resources associated with each node 114 from the remaining nodes 114. Specifically, as mentioned above, the nodes 114 associated with each tenant 204 are isolated form the nodes 114 associated with each remaining tenant 204. Thus, by providing such isolation, resources associated with each node 114 can also be isolated from each other. In some examples, the resources can include the resources associated with the database 116.

In some embodiments, the nodes 114 are heterogeneous nodes. Specifically, heterogeneous nodes 114 provide differing functionalities (or differing multiple functionalities). In other words, each of the nodes 114 provides differing functionalities.

A particular version, of one or more versions, of the identified particular node 114, is identified that is based on the message. Specifically, each message (e.g., the above-mentioned received message) can be associated with not only a particular node 114 (e.g., based on the functionality provided by the node 114) but can also be associated with a particular version of the particular node 114 (e.g., based on the functionality provided by the particular version of the particular node 114). For example, a first message can be associated with a previous version of a particular node 114 due to the tenant 204 that provides the message is operable/compatible with only a previous version of the particular node 114. In some examples, the first message is identified to be associated with ESB node 114, and further identified to be associated with the first version of the ESB node 114, shown as ESB node 114a. However, in some examples, a second message can be associated with an updated version of a particular node 114 due to the tenant 204 that provides the message is operable/compatible with only an updated version of the particular node 114. In some examples, the second message is identified to be associated with BPM node 114, and further identified to be associated with the second version of the BPM node 114, shown as BPM node 114b. In some examples, the message can be “tagged” with an association with the particular version of the particular node 114. In some examples, the metadata of the message can include the association with the particular version of the particular node 114. In some examples, the particular version of the particular node 114 is identified from multiple versions (e.g., two or more versions). In some embodiments, the dispatcher 208 identifies the particular version of the particular node 114.

Thus, the system 200 (and analogously, the system 100) supports multiple versions of the nodes 114 simultaneously (e.g., running in parallel). As a result, new versions of the nodes 114 can be introduced (e.g., provided for by the server 202) while minimizing, or preventing, shut down/downtime (e.g., preventing access to) older versions of the nodes 114. The system 200 facilitates “switching” to the newer version of a particular node 114 for tenants 204 that support the newer version while maintaining (e.g., retaining) the previous version of the particular node 114 for tenants 204 that cannot support the newer version of the particular node 114. For example, if a newer version of a particular node 114 is unacceptable (e.g., unstable or otherwise causes undesirable issues), the server 202 facilitates (e.g., allows) reverting to an older/previous version of the particular node 114. In some examples, each tenant 204 can be associated with predefined versions of the nodes 114.

In some embodiments, one or more of the nodes 114 are associated with a model (e.g., a program) that is executed by the respective node 114. The model defines how a message is to be handled (e.g., executed) by the node 114. In some examples, the model can be executed on each node 114, and each version of each node 1114. Additionally, the model can be associated with a version (i.e., multiple versions of a model). In some examples, a first version of the model can be executed on a first and a second version of a particular node 114, while a second (e.g., updated) version of the model can be executed only on the second version of the particular node 114. This is a result of the API of the second (e.g., updated) version of the particular node 114 being changed (e.g., incompatible versions of the model). Thus, system 220 (and analogously, the system 100) can provide (e.g., execute) models of incompatible versions by defining that the first version of a particular node 114 executes the first version of the model and the second version of a particular node 114 executes the second version of the model. Thus, this facilitates a decrease in the total cost of ownership (TCO) of the system 200 (or system 100) by minimizing, if not preventing, providing multiple different systems to handle the incompatible versions of the models.

In some embodiments, each version of a particular node 114 is mapped to (or associated with) the particular tenant 204 (e.g., the tenant 204 providing the message). Thus, by mapping each version of the particular node 114 to the particular tenant 204, the particular tenant 204 is able to access each version of the particular node 114 to maintain uptime of the server 202 and the particular node 114. In some examples, a subset of the versions of the particular node 114 is mapped to the particular tenant 204.

In some embodiments, each version of a particular node 114 is interoperable with each other (e.g., other versions of the particular node 114). In other words, each version of a particular node 114 is able to communicate or otherwise send/receive messages to the other versions of the particular node 114. By making each version of a particular node 114 interoperable with each other, the message may be effectively processed by the correct version of the node 114. In some examples, a subset of the versions of the particular node 114 are interoperable with each other.

The message is provided to the particular version of the particular node 114. The message (e.g., the message that is provided by the particular tenant 204 and received by the server 202/dispatcher 208) is provided (e.g., forwarded or transmitted) to the identified particular version of the identified particular node 114, as described above. The particular version of the particular node 114 can subsequently (e.g., after receiving the message) process the message as appropriate for the message and/or the particular tenant 204. For example, message processing can include mapping the message from a source format to a target format, message formatting, and message validation against a known schema.

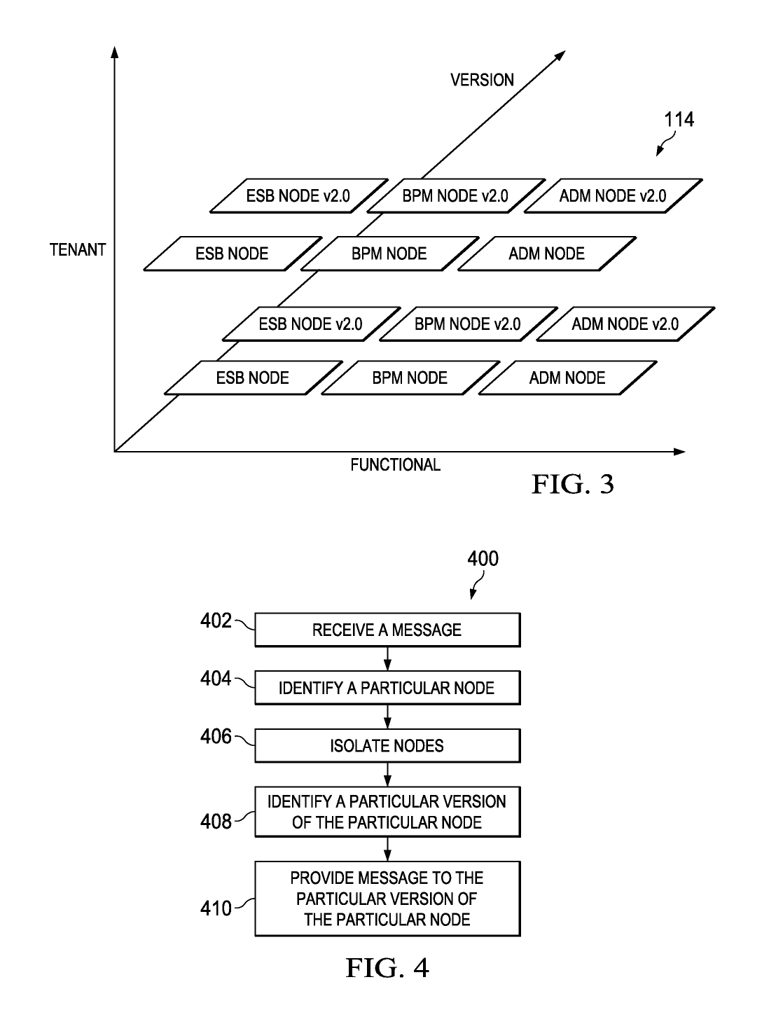

FIG. 3 illustrates a graphical depiction of the categorization of the nodes 114. Specifically, the nodes 114 are depicted in a Cartesian coordinate system along three axes. The three axes depict the differing categories (e.g., “dimensions”) that each of the nodes 114 can be characterized by. The categories (e.g., “dimensions”) can include, at least, function, version, and tenant. As mentioned above, with respect to the function category (e.g., function “dimension”), each of the nodes 114 provides (e.g., performs or executes) one or more functionalities. Thus, along the x-axis, each of the nodes 114 has a differing function, for example, ESB node 114, BPM node 114, and Adm Node 114. Additionally, as mentioned above, with respect to the version category (e.g., version “dimension”), the nodes 114 can be of different versions. Thus, along the z-axis, each of the nodes 114 (or, in some examples, a subset of the nodes 114) has multiple versions, for example, the ESB node, the BPM node 114, and the Adm Node 114 each have a first and a second version. Furthermore, as mentioned above, with respect to the tenant category (e.g., tenant “dimension”), each node 114 is mapped to (or associated with) a single tenant. Thus, along the y axis, there exists (e.g., stored by the server 202) multiple copies of the nodes 114 (and versions of the nodes 114) having the same functionality.

Turning now to FIG. 4, FIG. 4 is a flow chart 400 for managing nodes. For clarity of presentation, the description that follows generally describes method 400 in the context of FIGS. 1, 2, and 3. However, it will be understood that method 400 may be performed, for example, by any other suitable system, environment, software, and hardware, or a combination of systems, environments, software, and hardware as appropriate. For example, one or more of the server 102, the server 202, the client 140, or other computing device (not illustrated) can be used to execute method 400 and obtain any data from the memory of the server 102, the server 202, the client 140, or the other computing device (not illustrated).

In step 402, a message is received from a particular tenant of multiple tenants. For example, the dispatcher 208 receives the message from a particular tenant 204 of the multiple tenants 204. The message can include any representation of data, such as text, XML, or binary. In some examples, the message can be associated with the particular tenant 204. For example, the message can be encoded with data associated with the particular tenant.

In step 404, a particular node of the multiple nodes is identified that is (i) based on the message and that is (ii) mapped to the particular tenant. For example, the dispatcher 208 identifies the particular node 114 of the multiple nodes 114 that is (i) based on the received message (from the particular tenant 204) and that is (ii) mapped to (or associated with) the particular tenant 204. In some implementations, identifying the particular node 114 can include identifying encoded data of the message to identify the particular node 114. As a criterion, the particular node 114 is identified that provides the functionality that the message is associated with. In other words, the particular node 114 that provides a functionality to appropriately process the message (i.e., perform a desired function associated with the message) is identified. Additionally, as a criterion, the particular node 114 is identified that is mapped to the particular tenant 204. In some examples, each node 114 is mapped to only one tenant 204. Thus, while multiple nodes 114 may provide the same functionality, the node 114 that offers the identified functionality and is also associated with the particular tenant 204 is identified. In some examples, each node 114 provides one or more functionalities. In some examples, each tenant 204 is mapped to (or associated with) one or more nodes.

In some embodiments, each node is mapped to only one tenant. For example, each node 114 is mapped to (or associated with) only one tenant 204. In some examples, each tenant 204 includes a set of users (e.g., a corporation) accessing one or more physical entities (e.g., the server 202) that provide the multiple nodes 114. In some embodiments, each node 114 is a virtual machine. In some embodiments, the multiple nodes include heterogeneous nodes such that each node of the multiple nodes provides differing functionalities. For example, the nodes 114 are heterogeneous nodes such that each node 114 provides a differing functionality (or differing multiple functionalities).

In step 406, the nodes associated with each tenant are isolated form the nodes associated with each remaining tenant. For example, by identifying the particular node 114 based on the particular tenant 204, the nodes 114 are isolated from each other. In some examples, multiple tenants 204 may share (e.g., access) a single physical server (e.g., server 202) and/or a single database (e.g., database 116). To ensure that messages sent via the network 206 are secure and are properly forwarded to the appropriate node 114 (e.g., to prevent unauthorized access to the message and/or data associated with the message), the tenants 204, the nodes 114, and/or the resources associated with the nodes 114 (e.g., the data stored by the database 116) are isolated (e.g., segregated and/or partitioned) from one another. In some examples, access is substantially prevented of resources associated with each node 114 from the remaining nodes 114. In some embodiments, the dispatcher 208 isolates the nodes 114.

In step 408, a particular version, of one or more versions, of the particular node, is identified that is based on the message. For example, the distributer 208, identifies the particular version of the particular node 114 based on the received message (from the particular tenant 204). Each message (e.g., the above-mentioned received message) can be associated with not only a particular node 114 (e.g., based on the functionality provided by the node 114) but can also be associated with a particular version of the particular node 114 (e.g., based on the functionality provided by the particular version of the particular node 114). In some examples, each version of a particular node 114 is mapped to (or associated with) the particular tenant 204 (e.g., the tenant 204 providing the message).

In some embodiments, each version of a particular node is interoperable with each other. For example, each version of a particular node 114 is interoperable with each other version of the particular node 114. In other words, each version of a particular node 114 is able to communicate or otherwise send/receive messages to the other versions of the particular node 114.

In step 410, the message is provided to the particular version of the particular node. For example, the dispatcher 208 provides the message to the particular version of the particular node 114. The message (e.g., the message that is provided by the particular tenant 204 and received by the server 202/dispatcher 208) is provided (e.g., forwarded or transmitted) to the identified particular version of the identified particular node 114.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving a message from a particular tenant of a plurality of tenants;
identifying a particular node of a plurality of nodes that is based on the message and that is mapped to the particular tenant, each node providing one or more functionalities and each tenant mapped to one or more nodes;
identifying a particular version, of one or more versions, of the particular node that is based on the message, the particular tenant mapped to each version of the particular node; and
providing the message to the particular version of the particular node.

2. The computer-implemented method of claim 1, further comprising isolating the nodes associated with each tenant from the nodes associated with each remaining tenant.

3. The computer-implemented method of claim 2, wherein isolating further comprises substantially preventing access of resources associated with each node by the remaining nodes.

4. The computer-implemented method of claim 1, wherein each node is mapped to only one tenant, each tenant comprising a set of users accessing one or more physical entities providing the plurality of nodes.

5. The computer-implemented method of claim 1, wherein each node is a virtual machine.

6. The computer-implemented method of claim 1, wherein the plurality of nodes comprise a plurality of heterogeneous nodes such that each node of the plurality of heterogeneous nodes provides differing functionalities.

7. The computer-implemented method of claim 1, wherein the plurality of nodes comprise a plurality of heterogeneous nodes such that one or more nodes of the plurality of heterogeneous nodes includes two or more differing versions.

8. A computer storage medium encoded with a computer program, the program comprising instructions that when executed by one or more computers cause the one or more computers to perform operations comprising:
receiving a message from a particular tenant of a plurality of tenants;
identifying a particular node of a plurality of nodes that is based on the message and that is mapped to the particular tenant, each node providing one or more functionalities and each tenant mapped to one or more nodes;
identifying a particular version, of one or more versions, of the particular node that is based on the message, the particular tenant mapped to each version of the particular node; and
providing the message to the particular version of the particular node.

9. The computer storage medium of claim 8, wherein the operations further comprise:
isolating the nodes associated with each tenant from the nodes associated with each remaining tenant.

10. The computer storage medium of claim 9, wherein the operation of isolating further comprises substantially preventing access of resources associated with each node by the remaining nodes.

11. The computer storage medium of claim 8, wherein each node is mapped to only one tenant, each tenant comprising a set of users accessing one or more physical entities providing the plurality of nodes.

12. The computer storage medium of claim 8, wherein each node is a virtual machine.

13. The computer-implemented method of claim 8, wherein the plurality of nodes comprise a plurality of heterogeneous nodes such that each node of the plurality of heterogeneous nodes provides differing functionalities.

14. The computer storage medium of claim 8, wherein the plurality of nodes comprise a plurality of heterogeneous nodes such that one or more nodes of the plurality of heterogeneous nodes includes two or more differing versions.

15. A system of one or more computers configured to perform operations comprising:
receiving a message from a particular tenant of a plurality of tenants;
identifying a particular node of a plurality of nodes that is based on the message and that is mapped to the particular tenant, each node providing one or more functionalities and each tenant mapped to one or more nodes;
identifying a particular version, of one or more versions, of the particular node that is based on the message, the particular tenant mapped to each version of the particular node; and
providing the message to the particular version of the particular node.

16. The system of claim 15, wherein the operations further comprise:
isolating the nodes associated with each tenant from the nodes associated with each remaining tenant.

17. The system of claim 16, wherein the operation of isolating further comprises substantially preventing access of resources associated with each node by the remaining nodes.

18. The system of claim 15, wherein each node is mapped to only one tenant, each tenant comprising a set of users accessing one or more physical entities providing the plurality of nodes.

19. The system of claim 15, wherein each node is a virtual machine.

20. The system of claim 15, wherein the plurality of nodes comprise a plurality of heterogeneous nodes such that each node of the plurality of heterogeneous nodes provides differing functionalities.
